(19) United States
(12) Patent Application Publication
(10) Pub. No.: US 2017/0016213 A1
(43) Pub. Date: Jan. 19, 2017

(54) WATER SUPPLY SYSTEM UTILIZING COLLECTED AND STORED RAIN WATER AND MAINS WATER SUPPLY

(71) Applicants: Ugo Beltrami, Blackburn (AU); David Beltrami, Blackburn (AU); Antonio Beltrami, Blackburn (AU)

(72) Inventors: Ugo Beltrami, Blackburn (AU); David Beltrami, Blackburn (AU); Antonio Beltrami, Blackburn (AU)

(21) Appl. No.: 15/209,899

(22) Filed: Jul. 14, 2016

(30) Foreign Application Priority Data
Jul. 15, 2015 (AU) 2015902800

(51) Int. Cl. E03B 1/04; F16K 11/044; E03B 3/03

(52) U.S. Cl. CPC E03B 1/042; E03B 3/03; F16K 11/044; E03B 2001/047

(57) ABSTRACT

A valve arrangement for selectably directing water to an end user from either a first continuous mains pressure source of water or a second source of water supplied intermittently from a water storage facility by pump means (16), said valve arrangement (10) including a first valve means (44,59) being positionable in an open position permitting water from said first continuous mains pressure source to flow to said end user, said first valve means being movable to a closed position to prevent water flow from said first continuous mains pressure source to said end user, said first valve means being moved to said closed position by water pressure of water supplied from said second source by said pump means, said valve arrangement including a second valve means (23,58) positionable in an open condition or a closed condition, said second valve means being moved to said open condition by water pressure of water supplied from said second source by said pump means as said first valve means is moved to said closed position, said second valve means being movable to said closed condition by said first valve means being moved to said open position.

### FIELD OF THE INVENTION

The present invention relates to improvements in systems for supplementing mains water supply to domestic and commercial buildings with collected water, typically from rainfall, stored in storage tanks or the like.

### BACKGROUND OF THE INVENTION

With current climatic conditions and increasing requirements for water usage, water is becoming an increasingly scarce and expensive commodity. It is therefore more common to install rainfall collection and storage tanks with both new and existing buildings to provide a useful supplement for the conventional mains water supply. Normally, collected and stored rainfall will not always be sufficient on its own for the usage requirement of any building and as such, a convenient, simple and inexpensive control device for interfacing mains water supply with a locally collected and stored water supply is necessary. Such systems are known, for example, from Australian Innovation patent no. 2008100676, and Australian Standard patent application nos. 2010202174 and 2013205704. Such interfacing systems, apart from operating conveniently, simply, and efficiently, need also to prevent water from the locally collected source getting back into the mains water supply system to protect that system from possible undesirable contaminants.

The objective of the present invention is to provide an improved simple and effective interface arrangement that will enable water from a mains supply and water from a locally collected water source to be used by an end user, while protecting the mains supply from any possible cross contamination from the locally collected water source. A still further preferred objective is to provide a less expensive interface arrangement while still remaining effective in use.

### SUMMARY OF THE INVENTION

According to one aspect of the present invention, there is provided a valve arrangement for selectably directing water to an end user from either a first continuous mains pressure source of water or a second source of water supplied intermittently from a water storage facility by pump means, said valve arrangement including a first valve means being positionable in an open position permitting water from said first continuous mains pressure source to flow to said end user, said first valve means being movable to a closed position to prevent water flow from said first continuous mains pressure source to said end user, said first valve means being moved to said closed position by water pressure of water supplied from said second source by said pump means, said valve arrangement including a second valve means positionable in an open condition or a closed condition, said second valve means being moved to said open condition by water pressure of water supplied from said second source by said pump means as said first valve means is moved to said closed position, said second valve means being movable to said closed condition by said first valve means being moved to said open position.

The first valve means preferably includes a first seal surface cooperating with a first valve seat, said first seal surface being engageable with said first valve seat to place said first valve means in said closed position, said first seal surface being movable from said first valve seat to place said first valve means in said open position. The second valve means preferably includes a second seal surface cooperating with a second valve seat, said second seal surface being engageable with said second valve seat to place said second valve means in said closed condition, said second seal surface being movable from said second valve seat to place said second valve means in said open condition. The first seal surface and said second seal surface may be formed on a first movable valve member.

The valve arrangement preferably includes a first connection means adapted for connection, in use, to said first continuous mains pressure source of water, a second connection means adapted for connection, in use, to said second source of water supplied intermittently from a water storage facility by pump means, and a third connection means adapted for connection, in use, to said end user, each of said first, second and third connection means being in fluid communication with a central manifold chamber. The first connection means preferably includes at least one non-return valve permitting fluid flow towards the central manifold chamber but preventing fluid flow in a reverse direction. The second connection means preferably includes at least one non-return valve permitting fluid flow towards said central manifold chamber but preventing fluid flow in a reverse direction.

The first movable valve member is preferably moulded from a resilient elastomeric material. The first and second seal surfaces may be formed to face in opposite directions. Each of said first valve seat and said second valve may be circular or annular in configuration, the second valve seat having a diameter greater than said first valve seat.

The second connection means preferably includes a tubular passage terminating at its free end within said central manifold chamber, the free end of said tubular passage forming said second seal surface. A tubular member preferably extends from said first movable valve member telescopically over said tubular passage, said tubular member having one or more water flow openings that, in use, are either covered by the free end of said tubular passage or opened by relative movement of the tubular member and said tubular passage. A spring means preferably urges said first movable valve member towards said first valve seat. The spring means is preferably a helically wound spring surrounding said tubular passage. A spring based urging force is preferably applied by said spring means to said first movable valve member is adjustable.

The valve arrangement preferably includes a nut member engaging one end of said spring means and threadingly engaged on an external thread means of said tubular passage, said tubular passage being rotatably mounted to axially move said nut member relative to said tubular passage.

In accordance with a still further aspect, the present invention also provides a water supply system including a valve arrangement as described above, further including one or more water storage tank means forming a said second source, a water level sensing means to sense water level in said second source, and pumping means to pump water from said second source in response to sensed water level in said second source. Conveniently the pumping means is activated only when the sensed water level is above a predetermined minimum level.

A preferred embodiment of the present invention will hereinafter be described with reference to the accompanying drawings.

### BRIEF DESCRIPTION OF THE DRAWINGS

FIG. 1 is a section view through a preferred valve arrangement positioned in a condition where the mains water supply is active to provide water to the end user;

FIG. 2 is a section view similar to FIG. 1 where the valve arrangement is positioned in a condition where water from the collected storage system is supplied to the end user;

FIG. 2a is an enlarged section view of the movable valve member represented in FIGS. 1 and 2;

FIG. 3 is a schematic system view of a water supply system where the collected water storage system is at a predetermined minimum level and water is supplied to the end user from the mains pressure supply; and

FIG. 4 is a schematic system view similar to FIG. 3 wherein the collected water storage system is relatively full and water is supplied therefrom to the end user rather than from the mains pressure supply.

### DETAILED DESCRIPTION OF THE PREFERRED EMBODIMENTS

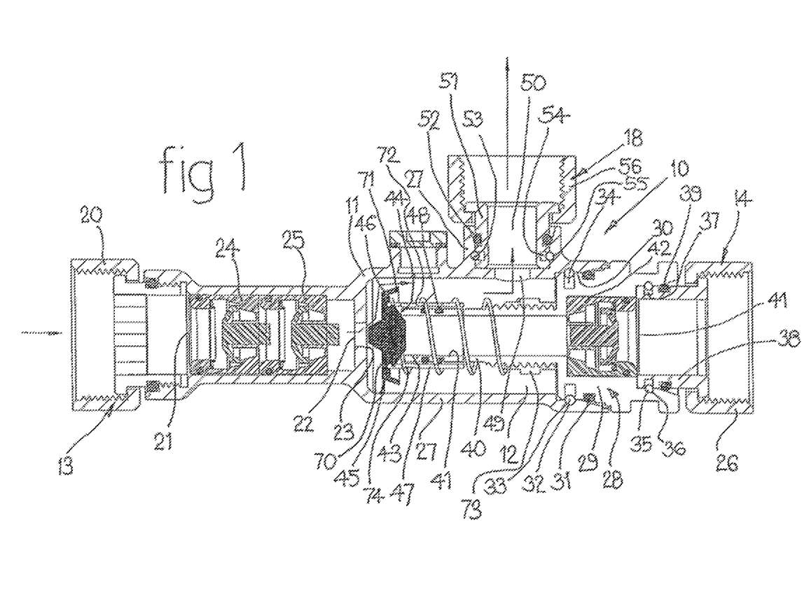

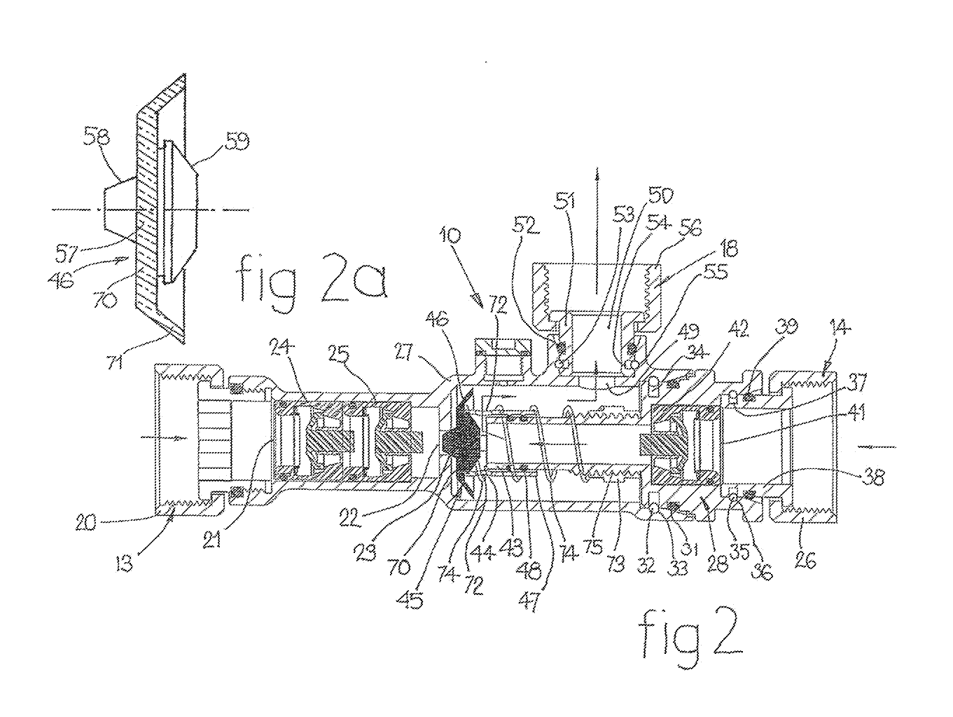

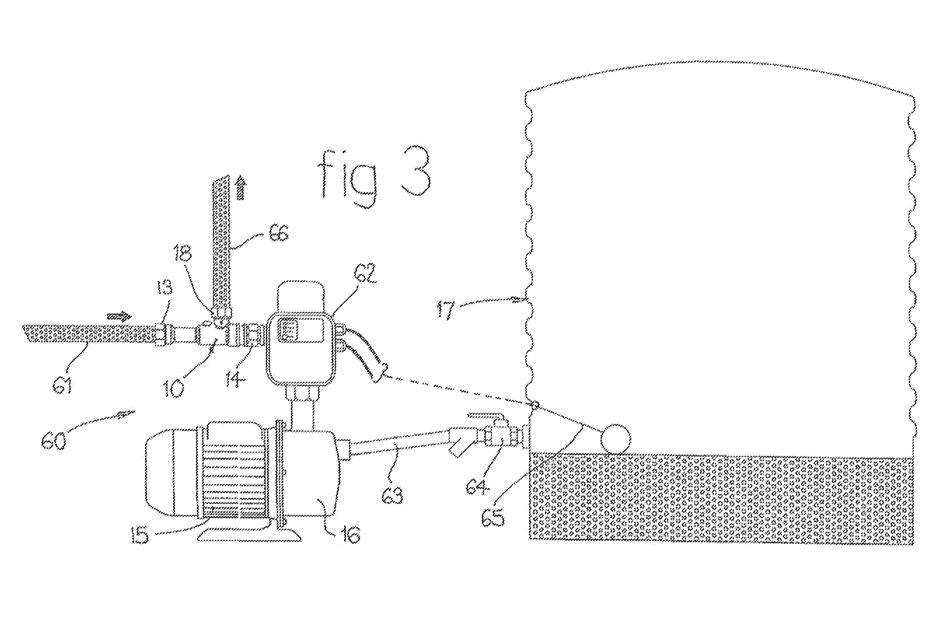

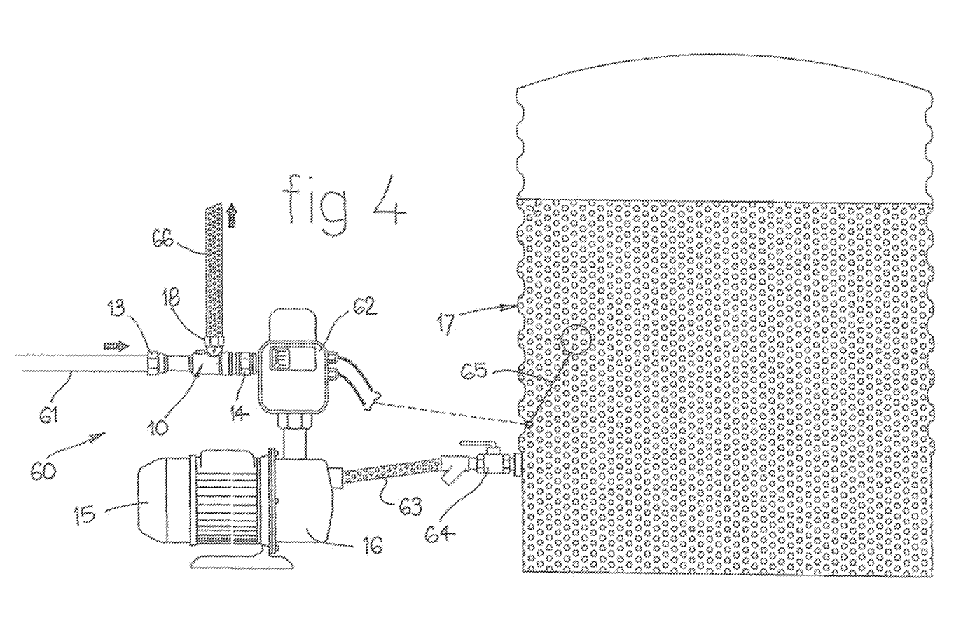

The annexed FIGS. 1 and 2 illustrate a preferred valve arrangement 10, having a main housing or body 11 with a central manifold chamber 12, a first connection means 13 intended, in use, to be connected to a mains pressure water supply, a second connection means 14 intended, in use, to be connected to a pressurised water supply from a storage system for collected rain water or the like. FIGS. 3 and 4 illustrate a water supply system 60 including the valve arrangement 10. The water supply system 60 includes a mains pressure water supply line 61 connected by the first connection means 13 to the valve arrangement 10. The second connection means 14 is connected via a controller 62 to pump 16 driven by a motor 15. The pump 16 receives water via a pipe 63 and valve 64 from a rain water storage tank 17. A water level sensing device 65 senses a pre-set minimum water level in the tank 17 and relays this to the controller 62. Once the controller 62 senses the water level has dropped to the pre-set minimum level, the controller 62 discontinues operation of the motor 15 driving the pump 16 such that no further water is drawn from the tank 17. The controller 62 does not restart the motor 15 to drive the pump 16 until a predetermined water level is sensed significantly above the pre-set minimum level. The level sensing device 65 is illustrated schematically as a float sensor but of course any form of sensing device can be used to sense tank water levels to provide appropriate signals to the controller 62. Water is supplied illustratively via line 66 to an end user that may be a domestic dwelling or any suitable commercial or industrial building capable of collecting and storing water from rainfall.

A preferred structure for the valve arrangement 10 is shown in FIGS. 1 and 2 of the annexed drawings. The first connection means 13 comprises an internally threaded nut 20 enabling connection to the end of the mains pressure water supply pipe 61. Of course any other form of known connection means might be used. The valve arrangement 10 includes a flow passage 21 leading to a first valve port 22 having a first valve seat 23 opening onto the central manifold chamber 12. Within the flow passage 21, a pair of non-return valves 24, 25 are positioned that allow water flow towards the central manifold chamber 12 defined within a valve housing 27 but not in a reverse direction towards the mains pressure water supply provided via line 61. The second connection 14 also includes an internally threaded nut 26 enabling connection of the valve arrangement 10 via the controller 62 and the pump 16 to the line 63 leading to the water storage tank 17. Of course any other known connection means could equally be used. The valve arrangement 10 includes a fitting member 28 having a first outer part 29 having a diameter adapted to fit within an outwardly open bore 30 in the valve housing 27 such that the first outer part 29 can rotate relative to the valve housing 27. A seal 31, such as an O-ring seal, provides a seal between the valve housing 27 and the first outer part 29 of the fitting member 28. A retainer ring 32 engageable within a groove 33 in the bore 30 of the valve housing 27 and a groove 34 in the outer surface of the outer part 29, retains the fitting member 28 in an axial direction but allows the fitting member 28 to rotate relative to the valve housing 27. A similar retainer ring 35 is located in between grooves 36, 37 in the member 28 and a further housing member 38 with an O-ring seal 39 operatively positioned between the two. The fitting member 28 includes a second inner part 40 having a smaller diameter than the first outer part 29, projecting into the central manifold chamber 12. The fitting member 28 includes an inner water flow passage 41 extending along its length to a free inner end terminating adjacent to but inwardly of the first valve seat 23. At least one non-return valve 42 is positioned in the flow passage 41, adjacent its outer end, that allows water flow towards the central manifold chamber 12 along the flow passage 41 but not in a reverse direction. A particular form of non-return valve construction is illustrated in the drawings for the non-return valves 24, 25 and 42, however, any other non-return valve construction could equally be used. The free end 43 of the second inner part 40 terminates in a second valve seat 44. A valve member 45 is positioned generally between the first valve seat 23 and the second valve seat 44, the valve member 45 including a valve body 46 and a tubular extension 47 telescopically engaged over the free end 43 of the second inner part 40 of the fitting member 28. Seal means 48 are positioned between the tubular extension 47 and the second inner part 40 of the fitting member 28.

The valve arrangement 10 still further includes an outlet flow passage 49 leading from the central manifold chamber 12 leading into a flow passage 50 of a valve housing part 51 that includes seal means 52 and a retainer ring 53 held in grooves 54, 55 to allow the housing part 51 to rotate relative to the valve housing 27. The third connection means 18 also is illustrated as an internally threaded nut 56 enabling connection to the line 66.

The valve body 46 is conveniently moulded from a resilient material capable of providing a suitable seal, in use, with the first and second valve seats 23, 44. The valve body includes a central section 57 having oppositely facing frustoconical seal surfaces 58, 59. The first frustoconical seal surface 58 facing towards the first valve port 22 is adapted (as shown in FIG. 2) to provide a seal with the first valve seat 23. The second frustoconical seal surface 59 faces towards the fitting member 28 and is adapted to provide a seal with the second seal seat 44 (FIG. 1). While the drawings illustrate frusto-conical seal surfaces 58, 59, other arrangements are also possible including, for example, oppositely facing domed seal surfaces. While the first and second valve seats 23, 24 are each formed by an edge zone of the port 22 or of the tubular extension 47 of the inner part 40, other constructions and configurations are possible. For example, the seal surfaces 58, 59 might be substantially flat so long as it is engageable in a sealing manner with the cooperating valve seat. The valve body 46 of the valve member 45 is movable axially between the positions shown in FIGS. 1 and 2 with the tubular extension 47 sliding over the second inner part 40 of the fitting member 41. The central part 70 of the valve body 46 is disc like with the outer perimeter part 71 being thinner and inclined or angled inwardly of the central manifold chamber 12. Because the outer perimeter part 71 is relatively more flexible than the central part 70, it will bend under water flow conditions as shown in FIG. 1.

As shown in FIGS. 1 and 2, the tubular extension 47 includes circumferentially spaced openings 72 to allow water flow from flow passage 41 outwardly past the second valve seat 44, through the central manifold chamber 12, and through the outlet port 49, when the valve arrangement 10 is positioned as shown in FIG. 2. As further shown in FIGS. 1 and 2, a nut 73 is threadingly engaged on a thread formation 75 formed on an outer face of the second inner part 40. The nut 73 has oppositely directed wings (not seen in the drawings) such that lateral outer ends of the wings are engaged in axially extending grooves (also not seen in the drawings), whereby the nut 73 cannot rotate but can move in an axial direction along the central manifold chamber 12. In consequence, rotation of the fitting member 28 causes the nut 73 to move axially. The nut 73 can move axially in fore and aft directions depending upon the direction of rotation of the fitting member 28. A compression helical spring 74 is engaged between the nut 73 and the valve body 46 to provide a selective and variable loading force on the valve body 46 to urge the valve body 46 towards the first valve seat 23. In some applications, the spring 74 might be omitted.

As represented in the drawings, if there is sufficient collected and stored water in the storage tank 17, the controller 62 senses that this is the case and activates the motor 15 and pump 16 to withdraw stored water from the tank 17 along line 63 to the flow passage 41. Water pressure in the flow passage 41 causes the valve member 45 to move to the left (FIG. 1) and in so doing, the seal surface 58 seals against the first valve seal 23 to prevent mains pressure supplied water entering the central manifold chamber 12. This mode of operation is illustrated in FIG. 2 where the water flow along flow passage 41 now can pass outwardly through the openings 72 into the chamber 12 and from there through the outlet port 49 to the end user along line 66. Movement of the valve member 45 may be assisted by the spring 74, if provided, and further, the operation of same can be adjusted by turning the fitting member 28 to vary the force applied to the valve member 45 by the spring 74. This enables some adjustment to allow for variations in the pressure of any mains pressure water supply. When the stored water in the tank 17 drops to a predetermined level, the motor/pump 15, 16 is turned off and water pressure in the flow passage 41 drops to a level that will not sustain the valve member 45 in the position illustrated in FIG. 2. As a result, mains pressure supply water in the flow passage 21 forces the valve member 45 to move to the position illustrated in FIG. 1, which closes the sealing surface 59 against the second valve seat 44. In this position (FIG. 1) of the valve arrangement 10, water is supplied to the end user along line 66 from the mains pressure supply and the supply flow passage 21.

It will of course be appreciated that modifications of the arrangement described with reference to the accompanying drawings are possible within the scope of the annexed patent claims.

1. A valve arrangement for selectably directing water to an end user from either a first continuous mains pressure source of water or a second source of water supplied intermittently from a water storage facility by pump means, said valve arrangement including a first valve means being positionable in an open position permitting water from said first continuous mains pressure source to flow to said end user, said first valve means being movable to a closed position to prevent water flow from said first continuous mains pressure source to said end user, said first valve means being moved to said closed position by water pressure of water supplied from said second source by said pump means, said valve arrangement including a second valve means positionable in an open condition or a closed condition, said second valve means being moved to said open condition by water pressure of water supplied from said second source by said pump means as said first valve means is moved to said closed position, said second valve means being movable to said closed condition by said first valve means being moved to said open position.

2. A valve arrangement according to claim 1 wherein said first valve means includes a first seal surface cooperating with a first valve seat, said first seal surface being engageable with said first valve seat to place said first valve means in said closed position, said first seal surface being movable from said first valve seat to place said first valve means in said open position.

3. A valve arrangement according to claim 2 wherein said second valve means includes a second seal surface cooperating with a second valve seat, said second seal surface being engageable with said second valve seat to place said second valve means in said closed condition, said second seal surface being movable from said second valve seat to place said second valve means in said open condition.

4. A valve arrangement according to claim 3 wherein said first seal surface and said second seal surface are formed on a first movable valve member.

5. A valve arrangement according to claim 2 including a first connection means adapted for connection, in use, to said first continuous mains pressure source of water, a second connection means adapted for connection, in use, to said second source of water supplied intermittently from a water storage facility by pump means, and a third connection means adapted for connection, in use, to said end user, each of said first, second and third connection means being in fluid communication with a central manifold chamber.

6. A valve arrangement according to claim 5 wherein said first connection means includes at least one non-return valve permitting fluid flow towards the central manifold chamber but preventing fluid flow in a reverse direction.

7. A valve arrangement according to claim 5 wherein said second connection means includes at least one non-return valve permitting fluid flow towards said central manifold chamber but preventing fluid flow in a reverse direction.

8. A valve arrangement according to claim 4 wherein said first movable valve member is moulded from a resilient elastomeric material.

9. A valve arrangement according to claim 8 wherein said first and said second seal surfaces are formed to face in opposite directions.

10. A valve arrangement according to claim 9 wherein each of said first valve seat and said second valve are circular or annular in configuration, the second valve seat having a diameter greater than said first valve seat.

11. A valve arrangement according to claim 5 wherein said second connection means includes a tubular passage terminating at its free end within said central manifold chamber, the free end of said tubular passage forming said second seal surface.

12. A valve arrangement according to claim 11 further including a tubular member extending from said first movable valve member telescopically over said tubular passage, said tubular member having one or more water flow openings that, in use, are either covered by the free end of said tubular passage or opened by relative movement of the tubular member and said tubular passage.

13. A valve arrangement according to claim 12 further including spring means to urge said first movable valve member towards said first valve seat.

14. A valve arrangement according to claim 13 wherein said spring means is a helically wound spring surrounding said tubular passage.

15. A valve arrangement according to claim 14 wherein a spring based urging force applied by said spring means to said first movable valve member is adjustable.

16. A valve arrangement according to claim 15 wherein a nut member engaging one end of said spring means is threadingly engaged on an external thread means of said tubular passage, said tubular passage being rotatably mounted to axially move said nut member relative to said tubular passage.

17. A water supply system including a valve arrangement as claimed in claim 1 further including one or more water storage tank means forming a said second source, a water level sensing means to sense water level in said second source, and pumping means to pump water from said second source in response to sensed water level in said second source.
